(19) United States
(12) Patent Application Publication
(10) Pub. No.: US 2017/0227673 A1
(43) Pub. Date: Aug. 10, 2017

(54) MATERIAL DETECTION SYSTEMS

(71) Applicant: Goodrich Corporation, Charlotte, NC (US)

(72) Inventors: Vivek Venugopalan, Bridgewater, NJ (US); Michael J. Giering, Bolton, CT (US); Kishore K. Reddy, Vernon, CT (US)

(21) Appl. No.: 15/017,740

(22) Filed: Feb. 8, 2016

(51) Int. Cl. G01V 8/10; G01N 21/84; G01N 21/27

(52) U.S. Cl. CPC G01V 8/10; G01N 21/27; G01N 21/84; G01N 2201/12

(57) ABSTRACT

A method for detecting one or more predetermined materials, includes receiving sensor data from an optical sensor system, wherein the sensor data indicates a plurality of wavelengths, processing, in real time, the sensor data using a recurrent neural network to correlate the sensor data with one or more predetermined materials, detecting the presence of the one or more predetermined materials based on the correlated sensor data, and outputting a correlation signal indicating whether the one or more predetermined materials have been detected. The method can further include receiving feedback from an operator indicating whether the correlation signal is accurate, and modifying a correlation model of the recurrent neural network based on the feedback to enhance correlating the sensor data to the one or more predetermined materials.

### BACKGROUND

### 1. Field

The present disclosure relates to optical detection systems, more specifically to optical material detection systems.

### 2. Description of Related Art

Multispectral sensing (e.g., for explosives detection) with emphasis on real time performance is being pursued by commercial and government agencies. Traditional spectral sensing methods and systems incur latency due to the volume of the subject being examined. No solutions for low latency/real time performance currently exist.

Such conventional methods and systems have generally been considered satisfactory for their intended purpose. However, there is still a need in the art for improved material detection systems. The present disclosure provides a solution for this need.

### SUMMARY

A method for detecting one or more predetermined materials, includes receiving sensor data from an optical sensor system, wherein the sensor data indicates a plurality of wavelengths, processing, in real time, the sensor data using a recurrent neural network to correlate the sensor data with one or more predetermined materials, detecting the presence of the one or more predetermined materials based on the correlated sensor data, and outputting a correlation signal indicating whether the one or more predetermined materials have been detected. The method can further include receiving feedback from an operator indicating whether the correlation signal is accurate, and modifying a correlation model of the recurrent neural network based on the feedback to enhance correlating the sensor data to the one or more predetermined materials.

Processing can include correlating a series of wavelengths with the existence of the one or more predetermined materials. Detecting the presence of one or more materials can include detecting the presence of one or more explosives or precursors thereof.

A system includes an optical sensing system configured to sense a plurality of wavelengths and output sensor data, and a material detection system operatively connected to the sensing system to receive the sensor data, wherein the material detection system includes a recurrent neural network and is configured to execute a method as described above.

The predetermined material can include one or more explosives or precursors thereof. The feedback can be a reward indicating a high correlation to the one or more predetermined materials.

A computer readable medium includes computer executable instructions configured to be executed by a processor, the instructions comprising a method as described above.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a flow chart of an embodiment of a method in accordance with this disclosure;

FIG. 2 is a schematic diagram of an embodiment of deep reinforcement learning in accordance with this disclosure; and

FIG. 3 is a schematic diagram of an embodiment of a system in accordance with this disclosure.

### DETAILED DESCRIPTION

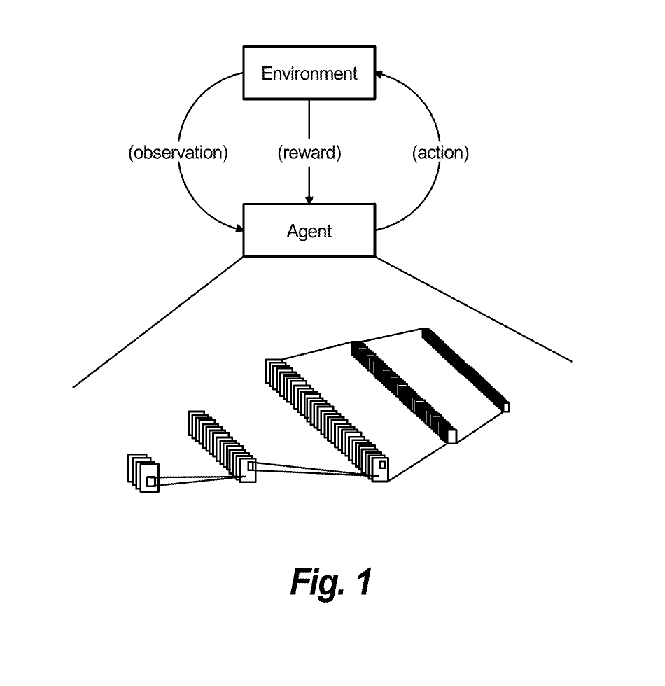

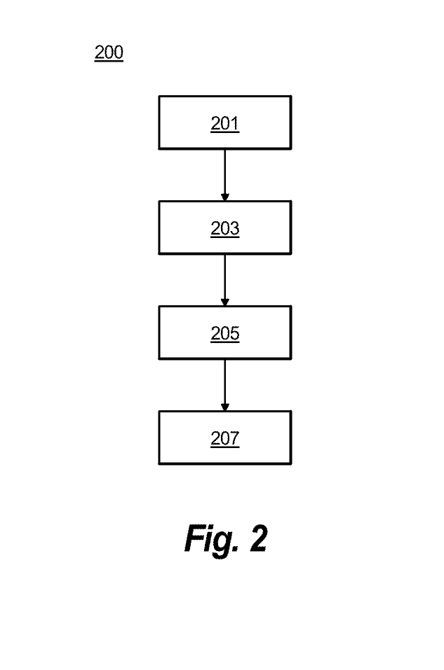

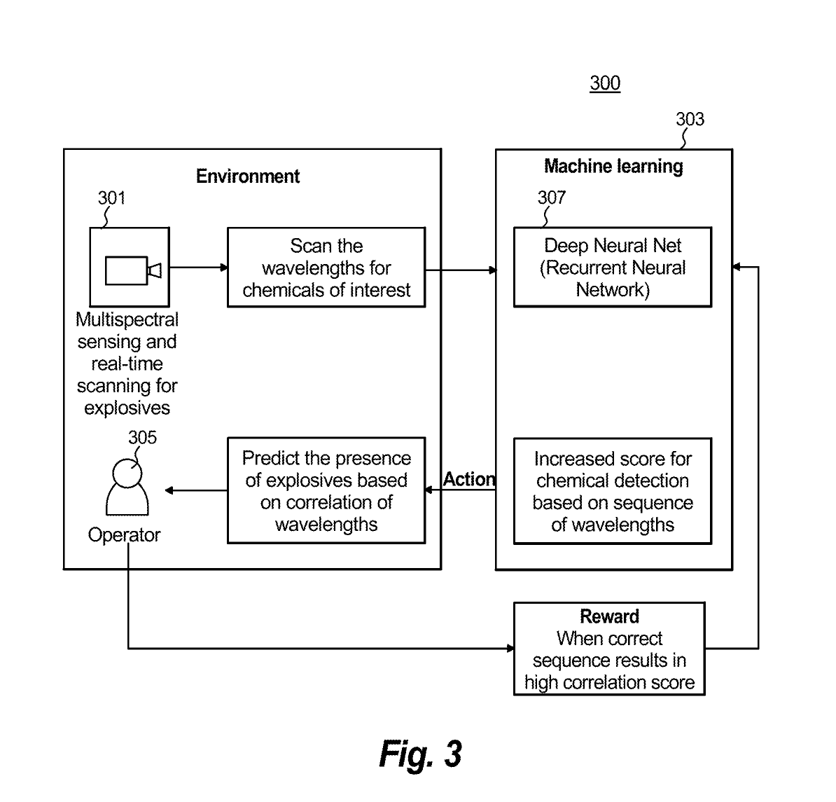

Reference will now be made to the drawings wherein like reference numerals identify similar structural features or aspects of the subject disclosure. For purposes of explanation and illustration, and not limitation, an illustrative view of an embodiment of a method in accordance with the disclosure is shown in FIG. 2 and is designated generally by reference character 200. Other embodiments and/or aspects of this disclosure are shown in FIGS. 1 and 3. The systems and methods described herein can be used to detect predetermined materials (e.g., explosives) with low latency (e.g., in real time or close thereto).

Referring to FIG. 1, generally, Reinforcement Learning (RL) evolved through learning to control agents from sensor outputs such as speech or video. Embodiments of this disclosure utilize a Deep Reinforcement Learning (DRL) method (e.g., as described above) to solve the correlation score prediction based on the sequence of wavelengths detected, e.g., for explosive threat detection. DRL has been used actively to target problems that interacts with the environment and learns by maximizing a scalar reward signal.

Deep Learning (DL) algorithms may require large amounts of labelled training data to generate a robust model that can be used for inference on testing data. Reinforcement learning (RL) algorithms must however, learn from a scalar reward signal that can be sparse, noisy, and delayed. Deep Reinforcement Learning (DRL) depends on a convolutional neural network (CNN) as the agent to generate the reward after learning from the sensor outputs.

Embodiments of a CNN are trained with a variant of the Q-learning algorithm as known in the art, where the weights are updated using stochastic gradient descent. Experience Replay is another technique used to store the agent's experiences at each timestep, eₜ=(sₜ; aₜ; rₜ; sₜ₊₁) in a dataset D=e₁, . . . , eₙ. This dataset D is pooled over many episodes into replay memory. Here, s denotes the sequence, a denotes the action, and r denotes the reward for a specific timestep. FIG. 1 shows the DRL approach with a CNN assuming the role of the agent.

After experience replay, the agent selects and executes an action as per the pre-defined greedy policy. Many of the weights are updated with each step of the experience permitting greater data efficiency. Randomizing the samples breaks the strong correlations between them and thus reduces the variances in the weight updates. The next set of parameters fed to the training phase are determined by the set of current parameters and the pre-defined policy. The main advantage of experience replay is that the behavior distribution is averaged over many of its previous states thus smoothing the learning and avoiding oscillations/divergence in the parameters.

The general CNN, however, is constrained as it accepts a fixed-size vector as input and produces a fixed-size vector as output. CNNs also extract features using a fixed amount of computational steps (e.g. the number of layers in the model). As compared to CNNs, RNNs operate over the sequence of vectors: sequences in input, output, or both. This property makes RNNs well suited for timeseries based feature extraction or sequence prediction.

In this regard, referring to FIGS. 2, a method 200 for detecting one or more predetermined materials (e.g., explosives, illegal drugs, or precursors thereof) includes receiving (e.g., at block 201) sensor data from an optical sensor system. The sensor data can indicate a plurality of wavelengths sensed by the optical sensor system. The method 200 further includes processing (e.g., at block 203), in real time, the sensor data using a recurrent neural network (RNN) to correlate the sensor data with one or more predetermined materials. Processing (e.g., at block 203) can include correlating a series of wavelengths with the existence of the one or more predetermined materials. For example, certain series of wavelengths existing in a predetermined ratio or magnitude can be correlated to certain materials.

The method 200 can further include detecting (e.g., at block 205) the presence of the one or more predetermined materials based on the correlated sensor data. Any suitable magnitude of correlation can be used to detect certain materials, such as, e.g., explosives, precursors thereof in a predetermined range (e.g., within a few feet from each other such that packages with mixing agents can be detected).

Detecting (e.g., at block 205) the presence of one or more materials can include detecting the presence of one or more explosives or precursors thereof. For example, certain explosives can be made of multiple compounds/elements that can be mixed. Household chemicals can make detection of an explosive device (e.g., an improvised explosive device) difficult. However, a presence of each compound/element within a predetermined area and/or in certain amounts can cause the determination that an explosive device is present.

The method 200 can include outputting (e.g., at block 209) a correlation signal indicating whether the one or more predetermined materials have been detected. The correlation signal can include an audible, tactile, visual, textual, or other indicator to indicate the presence of a certain material.

The method 200 can further include receiving feedback from an operator indicating whether the correlation signal is accurate. For example, the operator can verify whether a particular material (e.g., an explosive or device containing explosives) is present. The method 100 can include modifying a correlation model of the RNN based on the feedback to enhance correlating the sensor data to the one or more predetermined materials. An operator can reward the RNN when the determination is correct, which can reinforce the correlation model and enhance accuracy as well as reduce latency in determination.

Any suitable portions and/or the entirety of any suitable embodiments of a method 100 as described above can be implemented via any suitable computer hardware (e.g., memory, processor, etc.) and/or software. In the regard, a non-transitory computer readable medium (e.g., a memory) can include computer executable instructions configured to be executed by a processor, the instructions comprising any suitable portion(s) of a method as described above.

FIG. 3 shows a schematic diagram of a system and process (e.g., for explosive threat detection). The system 300 includes an optical sensing system 301 (e.g., a camera and/or the multispectral wavelength spectrometer) configured to sense a plurality of wavelengths and output sensor data. The optical sensing system 301 can be mounted to any suitable aircraft, vehicle, building, any other suitable location, or may be made for mobile use.

The system 300 can includes a material detection system 303 operatively connected to the sensing system 301 to receive the sensor data. The material detection system 303 includes an RNN as described herein and/or as appreciated by those skilled in the art. The material detection system 303 and/or the RNN are configured to perform a method as described above. Any suitable portion of the material detection system 303 can be implemented via any suitable computer hardware (e.g., memory, processor, etc.) and/or software (e.g., an RNN module, a detection module, a reward module). It is contemplated that the optical sensing system 301 and the material detection system 303 can be combined into a single unit, and/or that the material detection system 303 can be implemented in a controller associated with the optical sensing system 301.

As shown, the sensor system 301 and an operator 305 can be considered as part of the “environment,” and the material detection system can be considered the “agent.” A sequence of sensed wavelengths scanned are fed (as sensor data) to a Deep Neural (DN) network including an RNN 303. The correlation score indicating the presence of certain materials (e.g., explosives or components thereof) based on the sequence of wavelengths is the action provided by the RNN 303 (i.e., DRL agent) to the operator 305. A reward token is an operator 305 issued score which confirms the high correlation score to the presence of the predetermined material (e.g., explosives or any other suitable chemicals) which, in turn, fine-tunes the parameters of the RNN 303.

The trained model produced by the RNN 303 on the sequence of different chemical wavelengths can predict different correlation scores corresponding to the presence of the explosives or other suitable materials. This inference step evolves over time and reduces the latency considerably, as only a very small sample time and/or minimal wavelengths are required to accurately predict the presence of explosives or other materials. This can allow real-time performance of detection.

Latency is important to life safety and security when classifying chemical compounds in a typical real world environment. The use of, e.g., an IR spectrometer along with other sensor modalities (e.g., LiDAR or video) can identify areas of interest and highlight the target and background regions where suspected explosives or other suspect materials are. Several uncontrollable variables can be measured for IR spectroscopic based compound identification. The temporal data based on the chemical/substrate's reflectance spectrum and/or medium absorption can be used to classify the chemical compound and reduce the decision window based on prior decisions.

The temporal information can be exploited using RNNs to move from the observation stage to a decision stage quickly. The spatial information regarding the localization of the compound can addressed by the DRL method, e.g., where the augmented sensors such as video or LiDAR cameras can be moved by the DRL agent based on prior experience. The temporal sequence for prediction in the RNN can be determined by adequately training the model from previous decisions. The RNN can be initialized with small sequence of temporal information prior and ahead of the target spectra. Based on the correlation score and the reward assigned by the expert/user for correctly identifying the compound, the RNN can be adjusted to add a correct sequence to its dictionary. In case, the target spectrum is not of interest, the corresponding nodes in the RNN can be reset to avoid latency when observing such spectra in the future. The use of RNNs along with DRL highlights the spatio-temporal approach, eliminating the need for time-sensitive sensor calibration for background spectrum collection.

The methods and systems of the present disclosure, as described above and shown in the drawings, provide for material detection systems with superior properties including low latency/real time performance. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A system, comprising:
an optical sensing system configured to sense a plurality of wavelengths and output sensor data;
a material detection system operatively connected to the sensing system to receive the sensor data, wherein the material detection system includes a recurrent neural network and is configured to:
receive sensor data from an optical sensor system, wherein the sensor data indicates a plurality of wavelengths;
process, in real time, the sensor data using a recurrent neural network to correlate the sensor data with one or more predetermined materials;
detect the presence of the one or more predetermined materials based on the correlated sensor data; and
output a correlation signal indicating whether the one or more predetermined materials have been detected.

2. The system of claim 1, wherein the recurrent neural network is further configured to:
receive feedback from an operator indicating whether the correlation signal is accurate; and
modify a correlation model of the recurrent neural network based on the feedback to enhance correlating the sensor data to the one or more predetermined materials.

3. The system of claim 1, wherein the predetermined material includes one or more explosives or precursors thereof.

4. The system of claim 1, wherein the feedback is a reward indicating a high correlation to the one or more predetermined materials.

5. A method for detecting one or more predetermined materials, comprising:
receiving sensor data from an optical sensor system, wherein the sensor data indicates a plurality of wavelengths;
processing, in real time, the sensor data using a recurrent neural network to correlate the sensor data with the one or more predetermined materials;
detecting the presence of the one or more predetermined materials based on the correlated sensor data; and
outputting a correlation signal indicating whether the one or more predetermined materials have been detected.

6. The method of claim 5, further comprising:
receiving feedback from an operator indicating whether the correlation signal is accurate; and
modifying a correlation model of the recurrent neural network based on the feedback to enhance correlating the sensor data to the one or more predetermined materials.

7. The method of claim 5, wherein processing includes correlating a series of wavelengths with the existence of the one or more predetermined materials.

8. The method of claim 7, wherein detecting the presence of one or more materials includes detecting the presence of one or more explosives or precursors thereof.

9. A computer readable medium, comprising computer executable instructions configured to be executed by a processor, the instructions comprising:
receiving sensor data from an optical sensor system, wherein the sensor data indicates a plurality of wavelengths;
processing, in real time, the sensor data using a recurrent neural network to correlate the sensor data with one or more predetermined materials;
detecting the presence of the one or more predetermined materials based on the correlated sensor data; and
outputting a correlation signal indicating whether the one or more predetermined materials have been detected.
